(19) United States
(12) Patent Application Publication
(10) Pub. No.: US 2006/0106996 A1
(43) Pub. Date: May 18, 2006

(54) Updating data shared among systems

(76) Inventors: Said Abdullah Ahmad, Tucson, AZ (US); Thomas Charles Jarvis, Tucson, AZ (US); Kenneth Wayne Todd, Tucson, AZ (US)

Correspondence Address: KONRAD RAYNES & VICTOR, LLP, 315 S. BEVERLY DRIVE, # 210, BEVERLY HILLS, CA, 90212, US

(21) Appl. No.: 10/989,999

(22) Filed: Nov. 15, 2004

(51) Int. Cl. G06F 12/14

(52) U.S. Cl. 711/150

(57) ABSTRACT

Provided are a method, system and program for updating data shared among systems. A first and second systems maintain a first and second copies, respectively, of shared data stored in a storage device. The first system obtains a first lock to the shared data, wherein the first lock applies to the first system accessing the shared data. The first system sends to the second system a first message requesting a second lock to the shared data, wherein the second lock applies to the second system accessing the shared data; The second system obtains the second lock to the shared data for the first system in response to the first message sends to the first system a second message indicating the second lock to the shared data was granted.

### BACKGROUND OF THE INVENTION

1. Field of the Invention

The present invention relates to updating data shared among systems.

2. Description of the Related Art

In certain computing environments, multiple host systems may communicate with a control unit, such as an IBM Enterprise Storage Server (ESS)®, for data in a storage device managed by the ESS receiving the request, providing access to storage devices, such as interconnected hard disk drives through one or more logical paths. (IBM and ESS are registered trademarks of IBM). The interconnected drives may be configured as a Direct Access Storage Device (DASD), Redundant Array of Independent Disks (RAID), Just a Bunch of Disks (JBOD), etc. The control unit may include duplicate and redundant processing complexes, also known as clusters, to allow for failover to a surviving cluster in case one fails. The clusters may access critical metadata having information on status, state and configuration of the server including the clusters, which is necessary for cluster operations.

### SUMMARY

Provided are a method, system and program for updating data shared among systems. A first and second systems maintain a first and second copies, respectively, of shared data stored in a storage device. The first system obtains a first lock to the shared data, wherein the first lock applies to the first system accessing the shared data. The first system sends to the second system a first message requesting a second lock to the shared data, wherein the second lock applies to the second system accessing the shared data;. The second system obtains the second lock to the shared data for the first system in response to the first message sends to the first system a second message indicating the second lock to the shared data was granted.

### BRIEF DESCRIPTION OF THE DRAWINGS

FIG. 1 illustrates a computing environment in which embodiments are implemented.

FIG. 2 illustrates lock information maintained for shared data in a lock table.

FIGS. 3 and 4 illustrate operations to manage access to data shared between systems.

### DETAILED DESCRIPTION

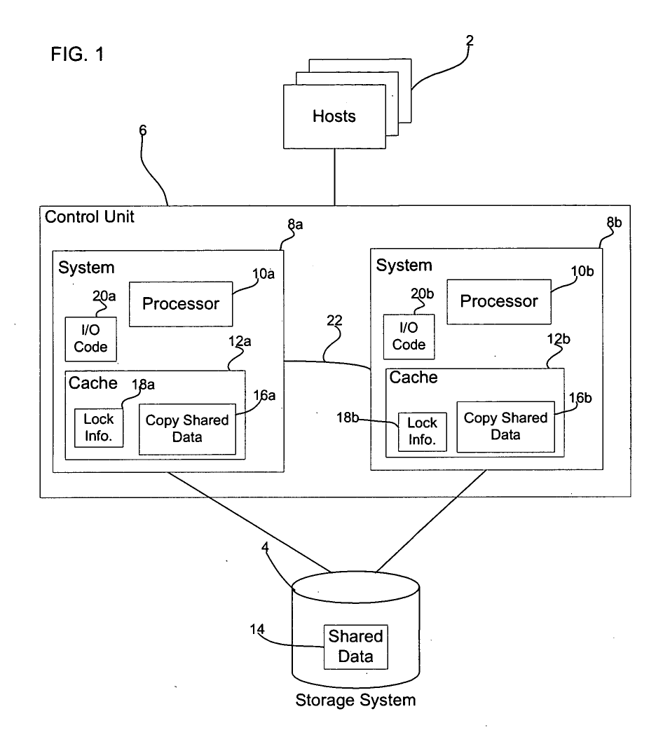

FIG. 1 illustrates a computing environment in which aspects of the invention are implemented. One or more hosts 2 communicate Input/Output (I/O) requests directed to a storage system 4 to a control unit 6, where the control unit 6 manages access to the storage system 4. In one embodiment, the control unit 6 is comprised of two systems 8a, 8b, each including a processor 10a, 10b and a cache 12a, 12b. Each system 8a, 8b may be on separate power boundaries. The systems 8a, 8b may be assigned to handle I/O requests directed to specific volumes configured in the storage system 4. The systems 8a, 8b communicate with the storage system 4 over a device network (not shown), which may comprise a local area network (LAN), storage area network (SAN), bus interface, serial interface, etc.

The storage system 4 includes shared data 14, comprising tracks accessible to both systems 8a, 8b. In one embodiment, the shared data 14 may comprise metadata, such as global metadata on the status, state or configuration of the control unit 6. The systems 8a, 8b may each maintain their own copy of the shared data 16a, 16b in their respective caches 12a, 12b for use within the system 8a, 8b. Each system 8a, 8b further maintains lock information 18a, 18b used to separately manage each system's 8a, 8b exclusive access to the shared data 14 through the granting and denial of locks to the shared data. The processors 8a, 8b execute I/O code 20a, 20b to manage I/O requests from the hosts 2 and metadata, and to manage locks to access the shared data 14. The processors 10a, 10b may communicate over a connection 22 enabling processor inter-communication to manage locks for the shared metadata 14.

The control unit 6 may comprise any type of server, such as an enterprise storage server, storage controller, etc., or other device used to manage I/O requests to attached storage system (s) 4, where the storage systems may comprise one or more storage devices known in the art, such as interconnected hard disk drives (e.g., configured as a DASD, RAID, JBOD, etc.), magnetic tape, electronic memory, etc. The hosts 2 may communicate with the control unit 6 over a network (not shown), such as a Local Area Network (LAN), Storage Area Network (SAN), Wide Area Network (WAN), wireless network, etc. Alternatively, the hosts 2 may communicate with the control unit 6 over a bus interface, such as a Peripheral Component Interconnect (PCI) bus or serial interface.

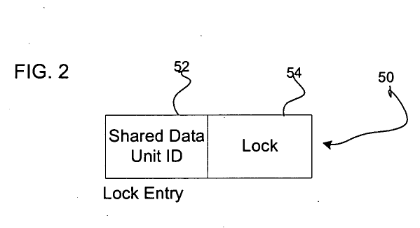

FIG. 2 illustrates a lock entry 50 maintained for each shared data unit, such as a track of shared data or shared metadata track, in the lock information 18a, 18b maintained by each system 8a, 8b. The lock entry 50 includes a shared data unit identifier (ID) 52, such as a track or metadata track identifier and a lock 54 for the identified shared data unit the system 8a, 8b maintaining the lock information uses to manage access to the identified shared data. Thus, each system 8a, 8b may separately maintain their own lock information 18a, 18b to separately manage locks with respect to their copies 16a, 16b of the same shared data 14 in the storage system 4.

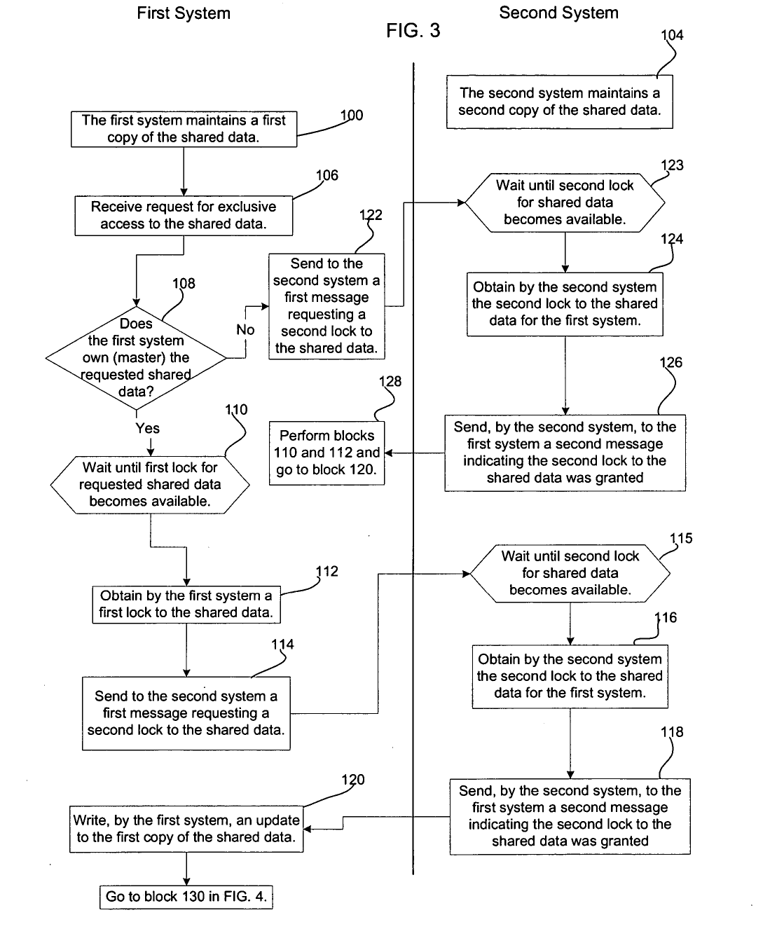

FIG. 3 illustrates an embodiment of operations implemented in the I/O code 20a, 20b executed by the processors 10a, 10b to manage metadata and cooperate. FIG. 3 shows operations performed by a first system 8a initiating access to shared data 14 and cooperating with a second system 8b, where either system 8a or 8b may function as the first or second system accessing the shared data 14. The first system 8a comprises the system attempting to access shared metadata and as part of accessing the copy of shared metadata 16a coordinates access with the second system 8b. Both systems 8a, 8b may maintain (at block 100 and 104) a local copy of requested the shared data 16a, 16b. The copies 16a, 16b are staged into the caches 12a, 12b in response to a previous request of the shared data 14 not found in the cache 12a, 12b or a prestaging operation. The first system 8a receives (at block 106) a request for exclusive access to the shared data 14, such as a track of shared data, which is maintained in the system cache 12a as the copy of shared data 16a. If the requested shared data 14 is not already in the cache 12a of the requesting first system 8a, then it would be staged into cache 12a. If (at block 108) the system 8a is the owner or master of the requested shared data 14, then the first system 8a waits (at block 110) for the first lock to the requested shared data 14, a copy 16a of which is maintained in the cache 12a. The first lock regulates the first system's 8a access to the copy 16a of the shared data 14. Upon the first lock for the requested shared data becoming available, the first system 8a obtains (at block 112) a first lock to the shared data 14. The first system 8a sends (at block 114) a first message requesting a second lock to the shared data 14. This second lock would prevent the second system 8b from updating the same shared data 14 while the first system 8a has exclusive access through the first lock, thus serializing write access to the shared data. In response to this first message, the second system 8b waits (at block 115) for the second lock to the shard data 14 to become available and then, when available, obtains (at block 116) the second lock to the shared data 14 for the first system 8a and sends (at block 118) to the first system 8a a second message indicating that the second lock to the shared data was granted. In response to the second message indicating that the second lock was granted, the first system 8a writes (at block 120) an update to the first copy of the shared data 16a.

If (at block 108) the system 8a is not the owner or master of the requested shared data 14, then the first system 8a sends (at block 122) to the second system 8b a first message requesting a second lock to the shared data. The second lock applies to the second system 8b accessing the shared data 14. The first system 8a requests that the second system 8b obtain the second lock on behalf of the first system 8a. In response to this first message, the second system 8b waits (at block 123) for the second lock to the shard data 14 to become available and then obtains (at block 124), when available, the second lock to the shared data 14, which regulates the second system's 8b access to the copy 16b of the shared data, on behalf of the first system 8a and then sends (at block 126) to the first system 8a a second message indicating the second lock to the shared data was granted. In response to this second message indicating that the second system 8b granted the second lock, the first system 8a performs (at block 128) the operations at 110 and 112 to obtain the first lock to the shared data 14 and then proceeds to block 120 to write the update to the shared data 14.

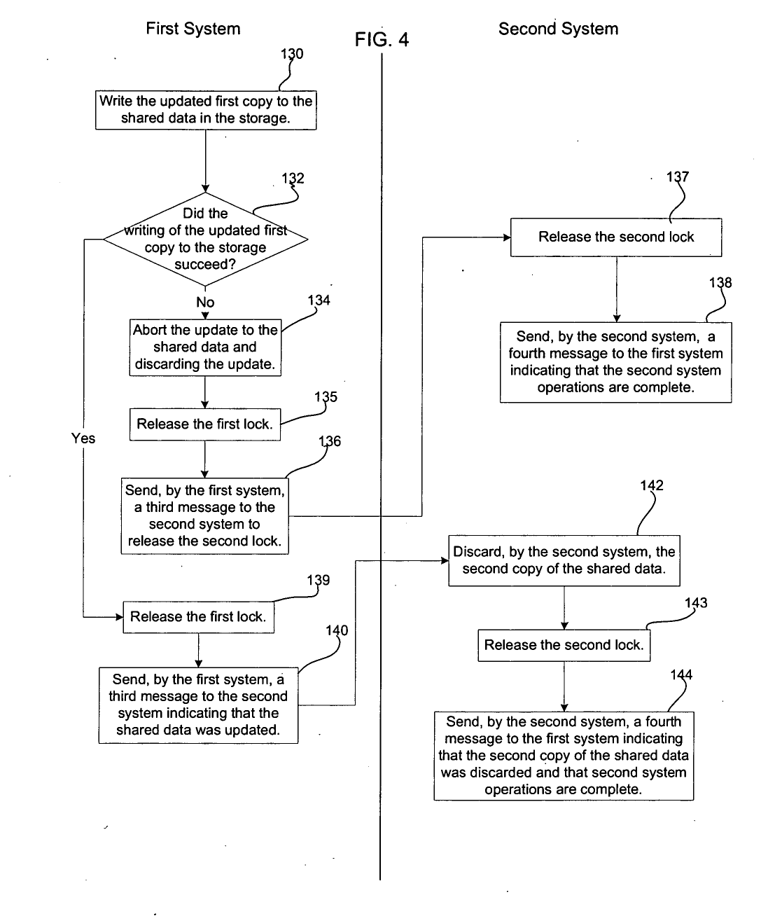

With respect to FIG. 4, the first system 8a writes (at block 130) the updated first copy 16a to the shared data 14 in the storage system 4. If (at block 132) the writing of the updated first copy 16a to the shared data 14 in the storage system 4 failed, then the first system 8a aborts (at block 134) the update to the shared data 14 and discards the update. The first lock is released (at block 135) to enable further access to the updated shared data. The first system 8a further sends (at block 136) a third message to the second system 8b to release the second lock to the shared data 14. In response to this third message, the second system 8b releases (at block 137) the second lock and sends (at block 138) a message to the first system 8a that the second lock was released and that the second system 8b operation is complete.

If (at block 130) the writing of the updated first copy 16a succeeded, then the first system 8a releases (at block 139) the first lock to enable further access to the updated shared data and sends (at block 140) a third message to the second system 8b indicating that the shared data 14 was updated. In response to this message, the second system 8b discards (at block 142) the second copy of the shared data 16b to avoid accessing the stale copy of the shared data 16b in the local cache 12b. If the second system 8b did not include a copy of the shared data 18b, then there would be no discard operation. As a result of discarding the copy 16b, the second system 8b must stage the updated shared data 14 into the cache 12b for subsequent accesses by the second system 8b to the shared data 14. The second system 8b further releases (at block 143) the second lock to enable further access to the updated shared data to the second system 8b. The second system 8b sends (at block 144) a fourth message to the first system 8a indicating that the second copy of the shared data 16b was discarded and that the second operation is complete.

### Additional Embodiment Details

The described embodiments may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

Certain embodiments may be directed to a method for deploying computing instruction by a person or automated processing integrating computer-readable code into a computing system, wherein the code in combination with the computing system is enabled to perform the operations of the described embodiments.

In the described embodiments, two systems 8a, 8b are capable of accessing the shared data. In additional embodiments, there may be more than two systems accessing the shared data. In such embodiments, one system would be designated as the master (owner) and the others slaves with respect to the shared data, such that a slave system with respect to shared data must first obtain a lock from the master system before obtaining the lock the slave system holds to the shared data. In this way, each of the three or more systems maintain there own copy of the shared data and lock information, and must coordinate their access with other systems to avoid conflicts. For instance, a system updating the shared data would have to obtain the lock for the shared data from every other system and then notify every other system upon updating the data to cause the other systems to discard any local copy they may have of the stale shared data.

FIG. 2 shows certain locking information used to manage the locks for the shared metadata. In alternative embodiments, this information may be stored in different data structures having different formats and information than shown.

The illustrated operations of FIGS. 3-4 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method, comprising:
maintaining, by a first system, a first copy of shared data stored in a storage device;
maintaining, by a second system, a second copy of the shared data;
obtaining by the first system a first lock to the shared data, wherein the first lock applies to the first system accessing the shared data;
sending, by the first system, to the second system a first message requesting a second lock to the shared data, wherein the second lock applies to the second system accessing the shared data;
obtaining by the second system the second lock to the shared data for the first system in response to the first message; and
sending, by the second system, to the first system a second message indicating the second lock to the shared data was granted.

2. The method of claim 1, wherein the shared data comprises global status metadata on a storage controller including the first and second systems.

3. The method of claim 1, further comprising:
writing, by the first system, an update to the first copy of the shared data in response to receiving the second message; and
writing the updated first copy to the shared data in the storage.

4. The method of claim 3, further comprising:
aborting, by the first system, the update of the shared data;
discarding, by the first system, the update;
releasing, by the first system, the first lock; and
sending, by the first system, a third message to the second system to release the second lock.

5. The method of claim 4, wherein the update to the shared data is aborted in response to a failure to write the updated first copy to the storage.

6. The method of claim 3, further comprising:
releasing, by the first system, the first lock;
sending, by the first system, a third message to the second system indicating that the shared data was updated; and
discarding, by the second system, the second copy of the shared data in response to the third message, wherein subsequent accesses by the second system to the shared data includes copying the shared data from the storage to a copy of the shared data maintained by the second system.

7. The method of claim 6, further comprising:
sending, by the second system, a fourth message to the first system indicating that the second copy of the shared data was discarded.

8. The method of claim 1, wherein the first system owns the shared data and further comprising:
receiving, by the first system, a request for exclusive access to the shared data; and
determining whether the first lock is available, wherein the first system obtains the first lock in response to determining that the first lock is available.

9. The method of claim 1, wherein the second system owns the shared data, and wherein the first system obtains the first lock to the shared data in response to receiving the second message.

10. The method of claim 9, further comprising:
receiving, by the first system, a request for exclusive access to the shared data; and
determining whether the first lock is available, wherein the first system sends the first message requesting the second lock in response to determining that the first lock is available.

11. A system, comprising:
a first system;
a first computer readable medium accessible to the first system;
a second system;
a second computer readable medium accessible to the second system;
a storage device accessible to both the first and second systems having shared data;
first code in the first computer readable medium executed by the first system to cause operations to be performed, the operations comprising:
(i) maintaining a first copy of the shared data;
(ii) obtaining a first lock to the shared data, wherein the first lock applies to the first system accessing the shared data; and
(iii) sending to the second system a first message requesting a second lock to the shared data, wherein the second lock applies to the second system accessing the shared data; and
second code in the second computer readable medium executed by the second system to cause operations to be performed, the operations comprising:
(i) maintaining a second copy of the shared data;
(ii) obtaining the second lock to the shared data for the first system in response to the first message; and
(iii) sending to the first system a second message indicating the second lock to the shared data was granted.

12. The system of claim 11, wherein the shared data comprises global status metadata on a storage controller including the first and second systems.

13. The system of claim 11, wherein the operations resulting from the execution of the first code further comprise:
writing an update to the first copy of the shared data in response to receiving the second message; and
writing the updated first copy to the shared data in the storage.

14. The system of claim 13, wherein the operations resulting from the execution of the first code further comprise:
aborting the update of the shared data;
discarding the update;
releasing the first lock; and
sending a third message to the second system to release the second lock.

15. The system of claim 14, wherein the update to the shared data is aborted in response to a failure to write the updated first copy to the storage.

16. The system of claim 13, wherein the operations resulting from the execution of the first code further comprise:
releasing the first lock;
sending, by the first system, a third message to the second system indicating that the shared data was updated; and
wherein the operations resulting from the execution of the second code further comprise discarding the second copy of the shared data in response to the third message, wherein subsequent accesses by the second system to the shared data includes copying the shared data from the storage to a copy of the shared data maintained by the second system.

17. The system of claim 16, wherein the operations resulting from the execution of the second code further comprise:
sending a fourth message to the first system indicating that the second copy of the shared data was discarded.

18. The system of claim 11, wherein the first system owns the shared data and wherein the operations resulting from the execution of the first code further comprise:
receiving a request for exclusive access to the shared data; and
determining whether the first lock is available, wherein the first system obtains the first lock in response to determining that the first lock is available.

19. The system of claim 11, wherein the second system owns the shared data, and wherein the first system obtains the first lock to the shared data in response to receiving the second message.

20. The system of claim 19, wherein the operations resulting from the execution of the first code further comprise:
receiving a request for exclusive access to the shared data; and
determining whether the first lock is available, wherein the first system sends the first message requesting the second lock in response to determining that the first lock is available.

21. An article of manufacture comprising code enabled to be executed by a first system and a second system to perform operations, wherein the first and second systems are in communication with a storage device having shared data, and wherein the operations comprise:
maintaining, by the first system, a first copy of shared data stored in the storage device;
maintaining, by the second system, a second copy of the shared data;
obtaining by the first system a first lock to the shared data, wherein the first lock applies to the first system accessing the shared data;
sending, by the first system, to the second system a first message requesting a second lock to the shared data, wherein the second lock applies to the second system accessing the shared data;
obtaining by the second system the second lock to the shared data for the first system in response to the first message; and
sending, by the second system, to the first system a second message indicating the second lock to the shared data was granted.

22. The article of manufacture of claim 21, wherein the shared data comprises global status metadata on a storage controller including the first and second systems.

23. The article of manufacture of claim 21, wherein the operations further comprise:
writing, by the first system, an update to the first copy of the shared data in response to receiving the second message; and
writing the updated first copy to the shared data in the storage.

24. The article of manufacture of claim 23, wherein the operations further comprise:
aborting, by the first system, the update of the shared data;
discarding, by the first system, the update;
releasing, by the first system, the first lock; and
sending, by the first system, a third message to the second system to release the second lock.

25. The article of manufacture of claim 24, wherein the update to the shared data is aborted in response to a failure to write the updated first copy to the storage.

26. The article of manufacture of claim 23, wherein the operations further comprise:
releasing, by the first system, the first lock;
sending, by the first system, a third message to the second system indicating that the shared data was updated; and
discarding, by the second system, the second copy of the shared data in response to the third message, wherein subsequent accesses by the second system to the shared data includes copying the shared data from the storage to a copy of the shared data maintained by the second system.

27. The article of manufacture of claim 21, wherein the operations further comprise:
sending, by the second system, a fourth message to the first system indicating that the second copy of the shared data was discarded.

28. The article of manufacture of claim 21, wherein the first system owns the shared data and wherein the operations further comprise:
receiving, by the first system, a request for exclusive access to the shared data; and
determining whether the first lock is available, wherein the first system obtains the first lock in response to determining that the first lock is available.

29. The article of manufacture of claim 21, wherein the second system owns the shared data, and wherein the first system obtains the first lock to the shared data in response to receiving the second message.

30. The article of manufacture of claim 29, wherein the operations further comprise:
receiving, by the first system, a request for exclusive access to the shared data; and
determining whether the first lock is available, wherein the first system sends the first message requesting the second lock in response to determining that the first lock is available.

31. A method for deploying computing instruction, comprising integrating computer-readable code into a first and second systems, wherein the code in combination with the first and second systems is enabled to cause the first and second systems to perform:
maintaining, by the first system, a first copy of shared data stored in a storage device;
maintaining, by the second system, a second copy of the shared data;
obtaining by the first system a first lock to the shared data, wherein the first lock applies to the first system accessing the shared data;
sending, by the first system, to the second system a first message requesting a second lock to the shared data, wherein the second lock applies to the second system accessing the shared data;
obtaining by the second system the second lock to the shared data for the first system in response to the first message; and
sending, by the second system, to the first system a second message indicating the second lock to the shared data was granted.

32. The method of claim 31, wherein the code is further enabled to cause the first system to perform:
writing, by the first system, an update to the first copy of the shared data in response to receiving the second message; and
writing the updated first copy to the shared data in the storage.

33. The method of claim 32, wherein the code is further enabled to cause the first system to perform:
aborting, by the first system, the update of the shared data;
discarding, by the first system, the update;
releasing, by the first system, the first lock; and
sending, by the first system, a third message to the second system to release the second lock.
